(19) United States
(12) Patent Application Publication
(10) Pub. No.: US 2023/0189898 A1
(43) Pub. Date: Jun. 22, 2023

(54) Aerosol Generation Device, Aerosol Generation System, Control Method

(71) Applicant: JT International SA, Geneva (CH)

(72) Inventors: Layth Sliman Bouchuiguir, Bellevue (CH); Akira Yamaguchi, Geneva (CH)

(73) Assignee: JT International SA, Geneva (CH)

(21) Appl. No.: 17/925,514

(22) PCT Filed: May 13, 2021
(86) PCT No.: PCT/EP2021/062793

§ 371 Date: Nov. 15, 2022

(30) Foreign Application Priority Data
May 15, 2020 (EP) 20175029.6

(51) Int. Cl. A24F 40/65; A24F 40/40; A24F 40/57; A24F 40/20

(52) U.S. Cl. CPC A24F 40/65; A24F 40/40; A24F 40/57; A24F 40/20

(57) ABSTRACT

An aerosol generation device including: a heating oven configured to receive and heat an aerosol generating substrate to generate an aerosol; and control circuitry configured to control the heating oven, wherein the control circuitry includes a communication module configured to communicate with a remote device, and the control circuitry is configured to enable or disable the communication module depending upon a current use state of the heating oven.

### TECHNICAL FIELD

The present disclosure relates to aerosol generation devices configured to heat an aerosol generating substrate to generate an aerosol. Such devices may heat or vaporise, rather than burn, tobacco or other suitable aerosol generating substrate materials by conduction, convection, and/or radiation, to generate an aerosol for inhalation.

### BACKGROUND

The popularity and use of reduced-risk or modified-risk devices (also known as vaporisers) has grown rapidly in the past few years as an aid to assist habitual smokers wishing to quit smoking traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn device. Devices of this type generate an aerosol or vapour by heating an aerosol generating substrate that typically comprises moist leaf tobacco or other suitable aerosolisable material to a temperature typically in the range 150° C. to 350° C. Heating an aerosol generating substrate, but not combusting or burning it, releases an aerosol that comprises the components sought by the user but not the toxic and carcinogenic by-products of combustion and burning. Furthermore, the aerosol produced by heating the tobacco or other aerosolisable material does not typically comprise the burnt or bitter taste resulting from combustion and burning that can be unpleasant for the user and so the substrate does not therefore require the sugars and other additives that are typically added to such materials to make the smoke and/or vapour more palatable for the user.

### SUMMARY

It is desirable for such aerosol generation devices to communicate with a remote device, for example, to extract usage data from the aerosol generation device or to enable remote control of the aerosol generation device or control of the aerosol generation device with an increased range of possible user inputs. However, such communication uses power and this power usage competes with the power usage required to heat the aerosol generating substrate. Accordingly, it is desirable to provide an aerosol generation device that is capable of communicating with a remote device without affecting its ability to heat an aerosol generating substrate.

According to a first aspect, the present disclosure provides an aerosol generation device comprising: a heating oven configured to receive and heat an aerosol generating substrate to generate an aerosol; and control circuitry configured to control the heating oven, wherein the control circuitry comprises a communication module configured to communicate with a remote device, and the control circuitry is configured to enable or disable the communication module depending upon a current use state of the heating oven.

Aerosol generation devices are typically designed to supply power the power required by a heating oven, and not much more than this. By enabling or disabling the communication module depending upon a current use state of the heating oven, the control circuitry can ensure that enough power can be supplied for both heating the aerosol generating substrate and for communicating using the communication module, without compromising the effectiveness of the heating or the communicating.

On the other hand, the communication module can drain energy available in the aerosol generation device. By limiting the use states in which the communication module is enabled, energy consumption of the aerosol generation device can be reduced.

Optionally, the heating oven comprises an opening and a moveable closure for the opening, and the current use state of the heating oven comprises a position of the moveable closure.

By determining the current use state of the heating oven based on a position of the moveable closure, the control circuitry can infer whether or not the aerosol generation device is currently in use, and thereby determine whether it is appropriate to enable or disable the communication module.

Optionally, the control circuitry is configured to enable the communication module when the moveable closure is in an open position.

When the moveable closure is in an open position, the heating oven is open. This is a state where it is likely that the heating oven is in use, recently used, or about to be used, because the heating oven is opened to insert or remove the aerosol generating substrate.

Optionally, the current use state of the heating oven comprises a change in the position of the moveable closure.

A change in the position of the moveable closure is likely to have been deliberately caused by a user of the device, and is another indication that the heating oven is in use, recently used, or about to be used.

Optionally, the moveable closure is a sliding closure configured to move along a rail.

Providing the moveable closure in the form of a sliding closure has the advantage that the moveable closure is easy to operate because it remains attached to the aerosol generation device and has a well-defined range of motion.

Optionally, the heating oven is configured to receive a consumable through the opening, and the consumable is longer than the heating oven such that the moveable closure is in an open position when the aerosol generating substrate is received in the heating oven.

Optionally, the moveable closure is biased to a closed position. With this configuration, the moveable closure can close the opening automatically. For example, the moveable closure may move to the closed position when there is no consumable present.

Optionally, the control circuitry is configured to control the heating oven to be in one or more aerosol generating states, and the current use state of the heating oven comprises a current aerosol generating state of the heating oven.

An aerosol generating state may have an associated power consumption of the heating oven, and the control circuitry may be configured to determine that it is inappropriate to simultaneously enable the communication module while supplying the required power to the heating oven in certain aerosol generating states.

Optionally, the aerosol generation device further comprises a temperature sensor, and the current use state of the heating oven comprises an indication of a temperature measured by the temperature sensor.

A temperature measured by the temperature sensor is a further indicator of whether power is required for the heating oven and/or an aerosol generating session has recently occurred, is currently occurring or is about to occur.

Optionally, the control circuitry is configured to enable the communication module when the current use state of the heating oven is an inactive state.

By enabling the communication module specifically when the heating oven is inactive, a stress on a power source for the aerosol generation device may be reduced.

Optionally, the communication module is configured to transmit usage data to the remote device.

Optionally, the communication module is configured to receive an instruction from the remote device, and the control circuitry is configured to control the heating oven based on the instruction.

Optionally, the control circuitry is configured to delay disabling the communication module until a communication session is complete. This has the advantage of increasing reliability of data transfer from the aerosol generation device to the remote device and/or instruction transfer from the remote device to the aerosol generation device.

Optionally, the aerosol generation device further comprises a communication indicator operable to indicate whether the communication module is enabled or disabled.

By indicating whether the communication module is enabled or disabled, a user can be prompted to keep the aerosol generation device within communication range of the remote device while they are communicating.

According to a second aspect, the present disclosure provides a system comprising an aerosol generation device as described above and the remote device, wherein the remote device is configured to run a software application for communicating with the aerosol generation device.

Optionally, the communication module is a wireless communication module, and the remote device is a user terminal. This configuration enables a user to conveniently use both the aerosol generation device and the remote device together to increase the user interface capabilities relative to the aerosol generation device alone.

According to a third aspect, the present disclosure provides a method of controlling an aerosol generation device comprising a heating oven configured to receive and heat an aerosol generating substrate to generate an aerosol; and a communication module configured to communicate with a remote device, wherein the method comprises comprising enabling or disabling the communication module depending upon a current use state of the heating oven.

The method may be performed by control circuitry arranged in the aerosol generation device. The control circuitry may store the method as computer program instructions in a memory, and execute the instructions using a processor, or the method may be hard coded in the control circuitry.

The method may also be stored as computer program instructions in a storage medium. When the instructions are read from the storage medium and executed by control circuitry, the control circuitry performs the method.

According to a first option for the method, the heating oven of the aerosol generation device comprises an opening and a moveable closure for the opening, and the current use state of the heating oven comprises a position of the moveable closure.

According to a first implementation of the first option, the method comprises enabling the communication module when the moveable closure is in an open position.

According to a second implementation of the first option, the current use state of the heating oven comprises a change in the position of the moveable closure.

According to a third implementation of the first option, the method is performed in an aerosol generation device where the moveable closure is a sliding closure configured to move along a rail.

Optionally, the method comprises controlling the heating oven to be in one or more aerosol generating states, and the current use state of the heating oven comprises a current aerosol generating state of the heating oven.

Optionally, the method is performed in an aerosol generation device further comprising a temperature sensor, and the current use state of the heating oven comprises an indication of a temperature measured by the temperature sensor.

Optionally, the method comprises enabling the communication module when the current use state of the heating oven is an inactive state.

Optionally, the method comprises controlling the communication module to transmit usage data to the remote device.

Optionally, the method comprises controlling the communication module to receive an instruction from the remote device, and controlling the heating oven based on the instruction.

Optionally, the method comprises delaying disabling the communication module until a communication session is complete.

Optionally, the method is performed in an aerosol generation device further comprising a communication indicator, and the method comprises controlling the communication indicator to indicate whether the communication module is enabled or disabled.

### BRIEF DESCRIPTION OF THE DRAWINGS

FIG. 1A is a schematic block diagram of an aerosol generation system associated with a first use state;

FIG. 1B is a schematic block diagram of the aerosol generation system associated with a second use state;

FIG. 2 is a schematic block diagram of the control circuitry 12.

FIG. 3 is a schematic timing diagram for controlling a heating oven;

FIGS. 4A to 4D are schematic external and cross-section illustrations of an aerosol generation device.

### DETAILED DESCRIPTION

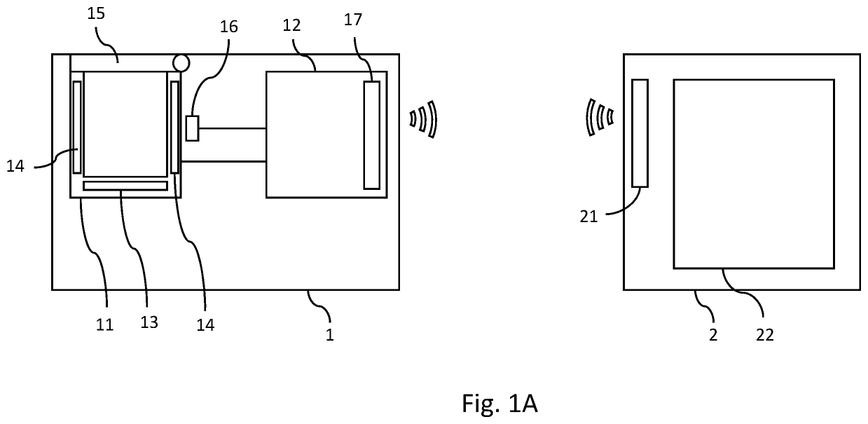

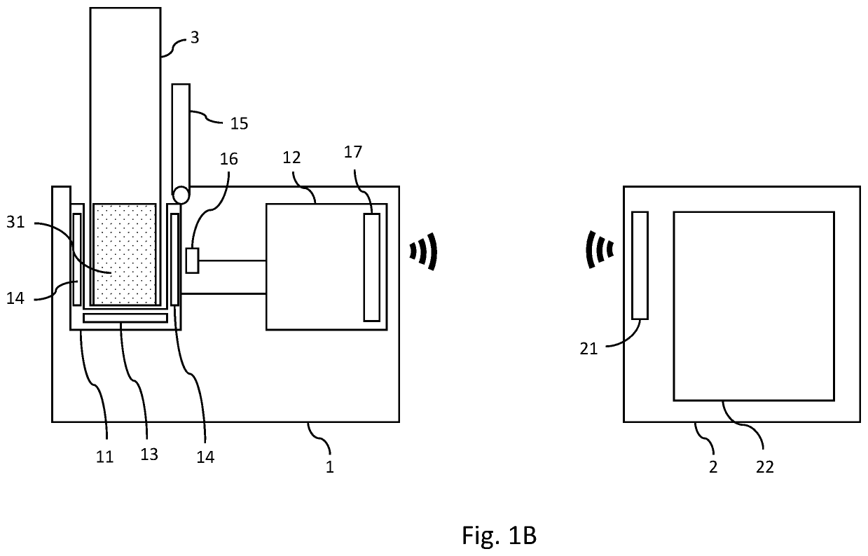

FIGS. 1A and 1B are schematic block diagrams of an aerosol generation system in different use states.

The system comprises an aerosol generation device 1 and a remote device 2.

The aerosol generation device 1 comprises a heating oven 11 configured to receive and heat an aerosol generating substrate to generate an aerosol, and control circuitry 12 configured to control the heating oven 11.

The heating oven 11 in this embodiment takes the form of a pot with an internal void in which the aerosol generating substrate can be positioned for heating. The pot may for example have a substantially cylindrical shape. One or more walls of the pot may be constructed from a ceramic or metal material.

The heating oven 11 comprises at least one heating element 13 arranged adjacent to or within a wall of the heating oven. As examples, the heating element 11 may take the form of a resistive heater deposited as a track on a wall of the heating oven, may take the form of a thin film heater arranged to wrap around an exterior wall of the heating oven, may be embedded within a wall of the heating oven, or may be a blade heater extending into the internal void. In general, any type of heating element 13 may be used. The heating element 13 is preferably an electrical heating element that can be controlled directly using an electronic switch (e.g. a transistor). The heating element 13 may alternatively be a chemical heating element configured to burn a fuel or cause an exothermic chemical reaction, in which case the heating element 13 may, for example, be controlled using a valve controlling supply of a chemical.

The heating oven 11 may additionally comprise one or more insulating elements 14 configured to reduce heat leakage from the heating oven into other parts of the aerosol generation device 1.

The aerosol generating substrate in this example is a solid substrate. The solid substrate may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant.

In this example, the heating oven 11 comprises an opening at one end of its pot shape, and further comprises a moveable closure 15. The moveable closure 15 is configured to move between a closed position (as shown in FIG. 1A) where the closure 15 blocks the opening of the heating oven 11, and an open position (as shown in FIG. 1B) where the closure 15 does not block the opening of the heating oven 11.

More specifically, in this example, the moveable closure 15 takes the form of a hinged lid with a well-defined range of motion. In other examples, the closure 15 may be more loosely attached to the aerosol generation device 1 (e.g. via a tether), or may not be permanently attached to the aerosol generation device at all (e.g. the closure 15 being held in the closed position only by a clip or a gasket, or the closure 15 being a bung or stopper). For such more loosely attached closures 15, the open position may be any position that is not the closed position.

The moveable closure 15 may be used in a number of different cases.

In one case, as shown in FIG. 1B, the aerosol generating substrate 31 is provided as part of a consumable 3 that is longer than the heating oven 11. The consumable 3 may, for example, take the form of a cigarette, with the substrate 31 wrapped in a wrapper. As a result of the consumable 3 being longer than the heating oven 11, the moveable closure 15 must be in the open position (shown in FIG. 1B) when the aerosol generating substrate 31 is received in the heating oven 11. On the other hand, when the consumable 3 has been consumed and disposed of, the moveable closure 15 can be moved to the closed position to prevent any other materials or objects from unintentionally entering the heating oven 11.

In another case, the aerosol generating substrate 31 may be sized to fit within the heating oven 11 (the substrate 31 being provided either as a packaged consumable or as loose material), and the moveable closure 15 can be moved to the closed position during heating of the aerosol generating substrate 31, in order to hold the substrate 31 within the heating oven 11 and/or to improve heating efficiency by inhibiting heat loss through the opening.

In any case, the moveable closure 15 may be biased towards the closed position, such that the moveable closure 15 will return to the closed position unless held open by hand or blocked by a consumable 3 that is currently extending through the opening. For example, when the moveable closure 15 takes the form of a hinged lid, the hinge may be biased towards the closed position by a spring.

As a further option, in addition to biasing the moveable closure 15 towards the closed position from at least one first open position, the moveable closure 15 may be biased towards a stable open position from at least one second open position. In other words, the moveable closure 15 may have a bi-stable configuration, in which the moveable closure 15 is biased towards either the closed position or a stable open position, depending upon its current position.

The control circuitry 12 may be configured to detect a position of the moveable closure 15. This can be implemented in many ways. For example, the closure 15 may comprise an electrical conductor configured to complete a circuit when in the open position. Alternatively, the opening may comprise a push switch which is closed when the closure 15 is in the closed position. Alternatively, the closure 15 may comprise a magnet and the aerosol generation device 1 may comprise a Hall effect sensor arranged to detect a distance between the sensor and the magnet.

The invention is generally applicable to any type of heating oven and any type of aerosol generating substrate. For example, the heating oven 11 may instead be configured to receive and heat a liquid substrate. In such cases, the liquid substrate may be transported to the heating oven 11 via a tube, and may be stored in a separate tank. Accordingly the opening of the heating oven 11 and the moveable closure 15 may be omitted. Alternatively, the heating oven 11 may itself act as a tank or receive a tank containing the liquid substrate, in which case the opening and moveable closure 15 may also be present.

Furthermore, the aerosol generation device 1 optionally comprises a temperature sensor 16. The temperature sensor 16 is preferably integrated with the heating oven 11, but may be arranged next to the heating oven 11, or may be arranged to measure a temperature of a different part of the aerosol generation device 1 such as a temperature of the control circuitry 12.

The control circuitry 12 comprises a communication module 17 configured to communicate with the remote device 2. The communication module 17 preferably comprises a wireless communication module. The wireless communication module may be, for example, a standardised communication module such as a Bluetooth® or WiFi® transceiver. The communication module 17 may additionally or alternatively comprise a wired communication module, such as a USB module.

The control circuitry 12 is configured to control enabling and disabling of the communication module 17. The communication module 17 may be a combination of hardware and software, and enabling/disabling the communication module may constitute enabling/disabling a part of the hardware, a part of the software or both.

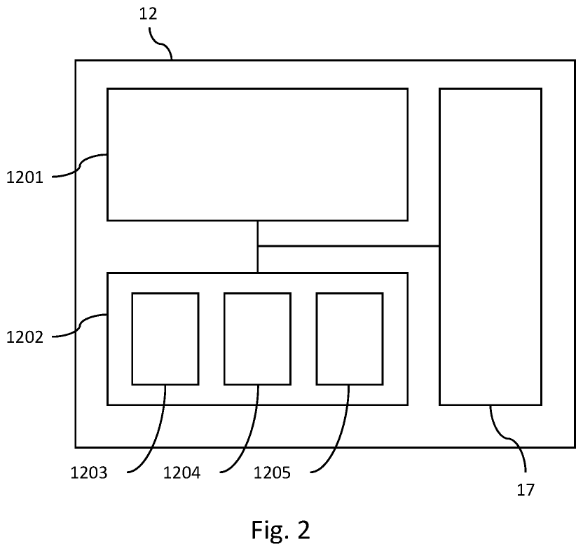

FIG. 2 is a schematic block diagram showing additional optional details of the control circuitry 12.

In addition to the communication module 17, the control circuitry 12 may comprise a processor 1201 configured to execute instructions and a memory 1202 configured to store instructions 1203 defining one or more control methods for controlling the heating oven 11 and the communication module 17. The instructions 1203 may be installed or updated by communication using the communication module 17. However, the control circuitry 12 need not have such a general-purpose architecture in all embodiments. For example, the control circuitry 12 may instead comprise an application specific integrated circuit (ASIC) configured to control the heating oven 11 and the communication module 17 substantially without storing any data in memory.

Referring again to FIGS. 1A and 1B, the remote device 2 comprises a communication module 21 and a user interface 22, and is configured to run a software application for communicating with the aerosol generation device 1.

The communication module 21 may be similar to the communication module 17 of the aerosol generation device 1.

The user interface 22 may, for example, comprise a touchscreen, a display and/or one or more buttons. The user interface 22 may be configured to display an application interface for a user to view information about the aerosol generation device 1 and/or for the user to remotely configure or control the aerosol generation device 1.

For example, the remote device 2 may be a user terminal such as a smartphone, tablet, laptop, PC etc. Preferably, the remote device is a user terminal and the communication modules 17 and 21 are wireless communication modules, such that a user of the aerosol generation device 1 can also conveniently use an application interface on the remote device 2. This enables the user to interact with the aerosol generation device 1 in more ways without requiring additional user interface elements on the aerosol generation device 1 itself.

The aerosol generation device 1 and the remote device 2 may communicate directly with each other, or may communicate via one or more networks. For example, the software application on the remote device 2 may be a Web-based application (for example implemented on a server or a cloud).

The above description of FIGS. 1A, 1B and 2 provides structural details and optional structural features of the aerosol generation device 1 and the remote device 2. In the next section of the description, there are described control methods which may be performed using such an aerosol generation device 1, for example being performed by the control circuitry 12.

The control circuitry 12 is configured to control the heating oven 11 to perform heating. For example, the control circuitry 12 may supply power, or control a supply of power, to the heating oven 11 at times when aerosol generation is required. The control circuitry may also be configured to control a heating rate of the heating oven 11 (i.e. a quantity of power dissipated as heat by the heating oven), for example by varying a voltage signal provided to the heating oven 11 or by using pulse width modulation on a signal provided to the heating oven 11.

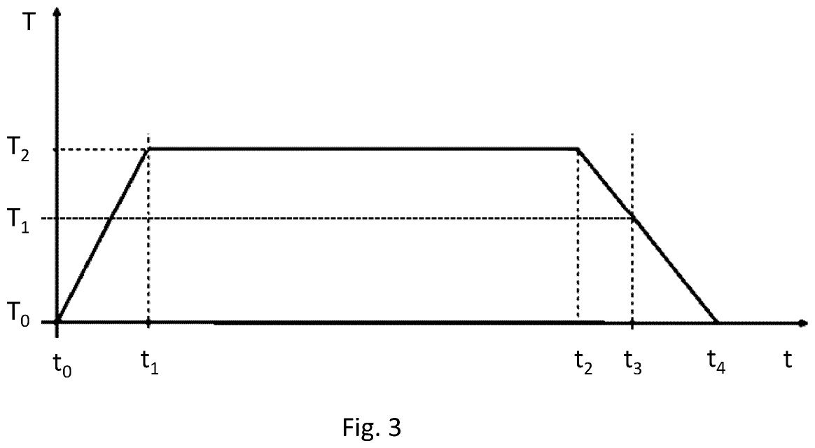

In one example, illustrated in FIG. 3, the control circuitry 12 is configured to control the heating oven 11 to progress through four aerosol generating states in an aerosol generation session. In FIG. 3, a t-axis indicates time, and a T-axis indicates temperature.

In a first state, which lasts from a starting time t₁ to a first time t₁, the temperature T rises relatively quickly from a starting temperature T₀ (e.g. ambient temperature) to a peak temperature T₂ which is at least high enough to cause the aerosol generating substrate to release the aerosol. The starting time t0 may be a time at which a user provides a user input to initiate an aerosol generating session, either via a user input element on the aerosol generation device 1 or via the user interface 22 on the remote device 2. The first state requires a relatively high power supply to increase the temperature T.

In a second state, which lasts from the first time t₁ to a second time t₂, the temperature T is maintained at or close to the peak temperature T₂. The second state may be a state in which a user inhales one or more puffs of aerosol from the aerosol generating substrate 31. The second state requires a lower power supply than the first state, as it is only necessary to maintain the temperature T.

In a third state, which lasts from second time t₂ to third time t₃, the temperature T is allowed to drop below the peak temperature T₂ until the temperature T is at a safe temperature T₁. The safe temperature T₁ may for example be a temperature at which it is safe to remove the aerosol generating substrate 31 from the heating oven 11, or a temperature at which it is safe to initiate a new aerosol generating session. The third state requires a lower power supply than the second state, and may not require power at all, because the temperature T is being allowed to drop.

In a fourth state, which lasts from third time t₃ to fourth time t₄, the temperature T is allowed to drop back to the initial temperature T₀ or an ambient temperature. The fourth state requires no power to the heating oven 11 because the temperature T is being allowed to drop further and the aerosol generating session is over.

The temperatures T₀, T₁ and T₂ may be measured temperatures, or may be assumed based on heating and cooling characteristics of the heating oven 11. On the other hand, the time periods (t₁-t₀), (t₂-t₁), (t₃-t₂) and (t₄-t₃) may be predetermined or may be determined according to corresponding aerosol generation thresholds or temperature thresholds being met. In one example, T₂ is 230° C., (t₁-t₀) is 20 seconds, and (t₂-t₁) is 250 seconds and (t₃-t₂) is 20 seconds.

In general, the control circuitry 12 may be configured to control the heating oven 11 to be in any one or more aerosol generating states during an aerosol generation session. The aerosol generating states may each comprise a respective temperature profile. Transitions between aerosol generating states may be controlled based, for example, on one or more of: timing by the timer of the control circuitry 12; a temperature measurement obtained from the temperature sensor 16; and a user input received via an input interface of the aerosol generation device or received from the remote device 2 via the communication module 17.

Additionally, the control circuitry 12 is configured to enable or disable the communication module depending on a current use state 1204 of the heating oven. The current use state may be determined by the control circuitry 12 as required and/or may be stored in the memory 1202.

In a first control case, the current use state 1204 of the heating oven is a set of information comprising a position of the moveable closure 15. The possible positions indicated in the current use state may, for example, include “CLOSED POSITION”, “NOT CLOSED POSITION”, and “OPEN POSITION”.

In the case shown in FIGS. 1A and 1B, the control circuitry 12 is configured to enable the communication module 17 when the moveable closure 15 is in an open position (as shown in FIG. 1B), and to disable the communication module 17 when the moveable closure 15 is in the closed position (as shown in FIG. 1A). This configuration has the advantage that the aerosol generation device 1 only consumes power for communication with the communication module 17 when it appears that the aerosol generation device 1 is currently in use, about to be in use, or recently used, for aerosol generation. As a result, the aerosol generation device 1 does not drain power between aerosol generating sessions.

Additionally, or alternatively, the current use state 1204 of the heating oven 11 may comprise a change in the position of the moveable closure 15. For example, the use state may indicate whether the position has been “CLOSED POSITION” and “NOT CLOSED POSITION” within a predetermined time period of a current time (e.g. 5 seconds). The control circuitry 12 may, for example, be configured to enable the communication module for a predetermined time after it is detected the position of the moveable closure 15 has changed. A change in the position of the moveable closure 15 indicates that a user is interacting with the aerosol generation device 1, and therefore this configuration provides an alternative way to enable the communication module 17 when the user has recently interacted with the aerosol generation device 1.

Additionally or alternatively, the control circuitry 12 may be configured enable or disable the communication module 17 in response to a predetermined sequence of changes in the position of the moveable closure 15 and/or in dependence upon a current enabled/disabled state of the communication module 17. For example, when the control circuitry 12 detects the sequence OPEN POSITION->CLOSED POSITION ->OPEN POSITION for positions of the moveable closure 15, the control circuitry 12 toggles the communication module 17 either from currently disabled to enabled, or from currently enabled to disabled.

Additionally or alternatively, the current use state 1204 of the heating oven 11 may comprise a current aerosol generating state of the heating oven (such as the aerosol generating states described above with respect to FIG. 3).

Preferably, the control circuitry 12 is configured to only enable the communication module 17 when the current use state 1204 of the heating oven 11 is an inactive state. For example, preferably the control circuitry 12 disables the communication module 17 when the heating oven 11 is in any of the aerosol generating states described above with respect to FIG. 3.

Alternatively, given that the first state (t₀ to t₁) in FIG. 3 requires a relatively high power supply to the heating oven 11, the aerosol generation device 1 may be unable to effectively supply this required power while also operating the communication module 17, and therefore the control circuitry 12 may preferably disable the communication module 17 so that aerosol generation can be properly performed. On the other hand, in the third and fourth states (t₂ to t₄) in FIG. 3, less power is required by the heating oven 11, and the control circuitry 12 may be configured to enable the communication module 17.

The control circuitry 12 controls the current aerosol generating state, so this is immediately known for the control circuitry 12 to decide whether to enable or disable the communication module 17. As a further alternative, the current use state 1204 of the heating oven may comprise an indication of a temperature measured by the temperature sensor 16. For example, the current use state 1204 of the heating oven may comprise an indication of whether the measured temperature is above or below a recent activity threshold T₄ where, if the temperature is above the threshold T₄, the control circuitry 12 detects that the heating oven 11 has been used recently, even if the control circuitry 12 is not currently controlling the heating oven 11 to be in an aerosol generating state.

As a further alternative, the current use state 1204 may comprise a measurement of the current or power currently being supplied to the heating oven 11 and, if the current or power is above a threshold, the control circuitry 12 disables the communication module 17.

Once the communication module 17 has been enabled according to one of the above-described criteria, the communication module 17 attempts to establish a connection to the communication module 21 of the remote device 2. This may be achieved by detecting a broadcast signal output by the remote device 2 to indicate its availability, and replying to the broadcast signal. Alternatively, the communication module 17 may generate a broadcast signal and await a reply from the remote device 2. Establishing this connection may require passing a security check, such as Bluetooth® pairing. The communication module 17 may use a similar procedure when attempting to re-establish a broken connection.

The control circuitry 12 may be configured to disable the communication module 17 after a predetermined period (e.g. one minute), in the case that the communication module 17 fails to establish a connection. This avoids continuously broadcasting or listening for a broadcast in the case that the remote device 2 is not actually nearby (in the case of direct communication) or not connected to the network (in the case of communication via a network). The control circuitry 12 may follow a similar procedure when the communication module 17 fails to re-establish a broken connection for a predetermined period.

The control circuitry 12 may further be configured not to disable the communication module 17 while a communication session is ongoing. For example, if the communication module 17 has only transmitted or received part of a current message at a time when disabling the communication module 17 is triggered according to one of the above procedures, the control circuitry 12 may delay disabling the communication module 17 until the communication session is complete. This has the advantage of reducing the risk of losing data.

Once a communication connection between the aerosol generation device 1 and the remote device 2 has been established, the connection may be used for a number of purposes.

In one example, the control circuitry may be configured to store usage data 1205 in memory 1202. The usage data may for example comprise one or more of: a count of a number of aerosol generating sessions which have been performed using the aerosol generation device 1; a time stamp for each aerosol generating session; a number of puffs of aerosol which are inhaled in each aerosol generating session (this can be detected by identifying temperature drops associated with a user drawing air and aerosol out of the heating oven 11); and/or a type of consumable or a type of aerosol generating substrate used for each aerosol generating session.

The control circuitry 12 may further be configured to transmit the usage data 1205 to the remote device 2 when the communication connection is established.

When transmitting data to the remote device 2, the control circuitry 12 may be configured to retain a copy of the usage data 1205 until receipt of the usage data is confirmed by the remote device 2. This increases reliability of communication over the communication connection. Alternatively, the control circuitry 12 may be configured to delete the usage data from memory 1202 when the usage data 1205 has been transmitted.

The software application on the remote device 2 may, as examples, be configured to: perform statistical analysis of the usage data 1205; to transmit the usage data 1205 to a server or cloud; and/or to present the usage data 1205 or a statistical analysis of the usage data 1205 via the user interface 22.

In another example of using the communication connection between communication module 17 and communication module 21, the remote device 2 may use the communication connection to send an instruction to the communication module 17. The control circuitry 12 may then control the heating oven 11 based on the instruction.

For example, the instruction may define a new set of aerosol generating states for an aerosol generating session. The control circuitry 12 may then control the heating oven 11 to be in the new set of aerosol generating states when an aerosol generating session is next performed. As described above for FIG. 3, the new set of aerosol generating states may specify one or more target temperatures and one or more time periods for the set of aerosol generating states.

Additionally or alternatively, the instruction may directly instruct the control circuitry 12 to begin controlling an aerosol generating session.

As a further possibility, the instruction may instruct the control circuitry 12 to change which usage data 1205 it is configured to record in the memory 1202.

In another example, the connection may be used to communicate a current status of the aerosol generation device 1 to the remote device 2. For example, a current status of an internal power source of the aerosol generation device 1 (such as a battery) may be communicated to the remote device 2. Additionally or alternatively, a current use state of the heating oven may be communicated to the remote device 2. The current use state may be a current one of a sequence of phases of an aerosol generation session, such as one of the aerosol generating states described above with reference to FIG. 3. The remote device 2 may display at least part of the status in the user interface 22. Transmission of the current use state of the heating oven does not need to involve huge amount of data and does not need to put much stress on the power source, and thus can in some cases be allowed during an aerosol generation session. Providing the use state of heating oven to the remote device 2 (e.g., smartphone) can advantageously provide an indication of the device state. With such information on use state of oven, the smartphone can determine whether or not to transmit data, in particular large sized data transmissions, to the aerosol generation device 1 as the aerosol generation device 1 may not optimally support large quantity data communication with the remote device 2 in some or all phases of the aerosol generation session described. As described previously, the aerosol generation device 1 enables or disables the communication module depending on a current use state of the heating oven.

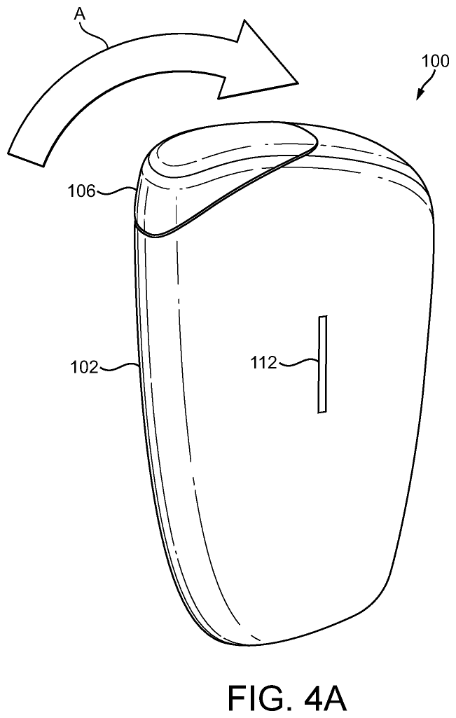

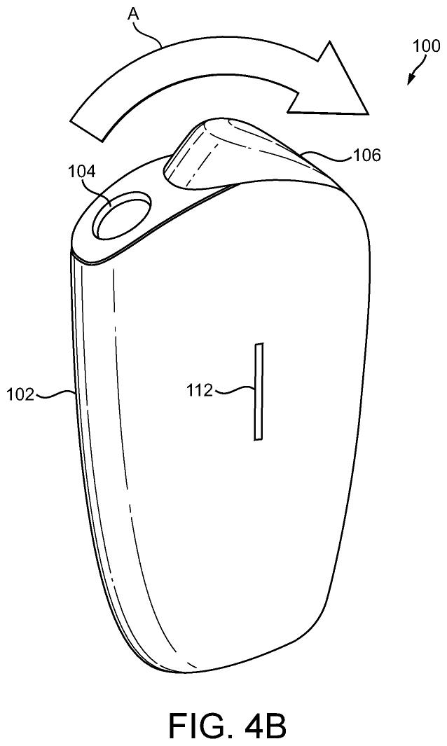

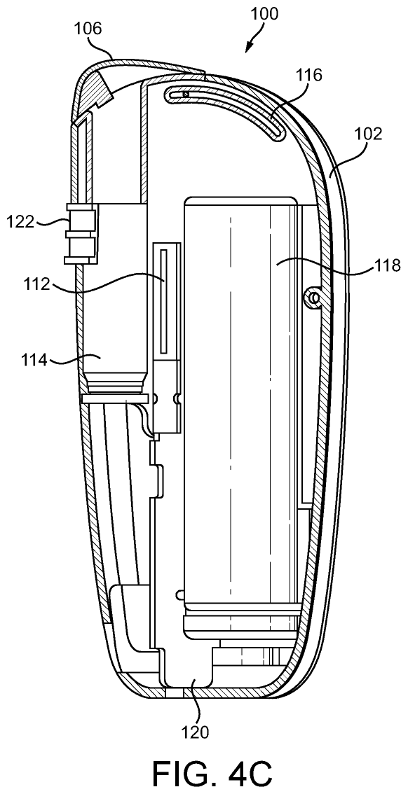

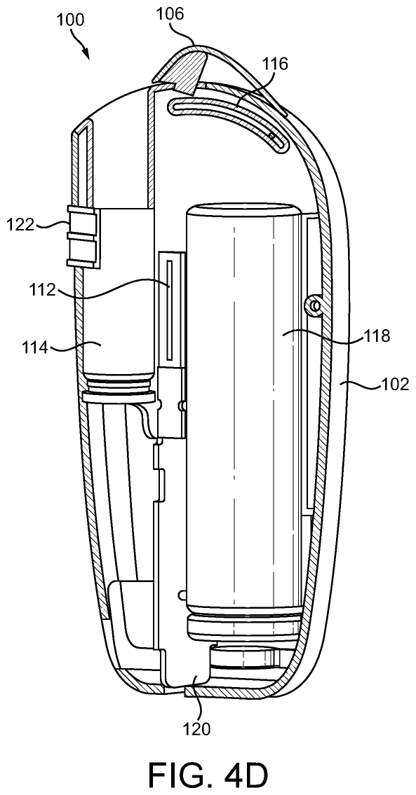

FIGS. 4A to 4D are schematic external and cross-section illustrations of a more detailed specific example of an aerosol generation device 100. The more detailed specific example may be operated according to any of the above-described control methods.

For the aerosol generation device 100, the moveable closure 15 takes the form of a sliding closure 106. The sliding closure 106 is configured to move between a closed position as shown in FIG. 4A and an open position as shown in FIG. 4B.

When the sliding closure 106 is in the open position, the opening 104 of the heating oven 114 is exposed to receive an aerosol generating substrate.

The sliding closure 106 may be configured to move freely, may be biased towards the closed position, or may have a bi-stable configuration in which the sliding closure 106 is biased towards either the closed position or the open position, depending upon its current position.

Additionally, as shown in the detailed specific example, the aerosol generation device 100 may include a user interface 112. The user interface 112 may be arranged at least partly on a housing 102 of the device 100.

The user interface 112 may comprise one or more user inputs such as buttons and sliders for providing user input to the control circuitry 12. For example, a button may be used to trigger the start of an aerosol generating session.

Additionally, the user interface 112 may comprise one or more status indicators such as lights (e.g. LEDs), or haptic output devices (vibrators or sound generators), the status indicators being controlled by the control circuitry 12. Haptic output devices may equally be arranged inside the housing 102, and even lights may be arranged inside the housing 102 if the housing 102 comprises one or more transparent or translucent portions.

In one example, a status indicator indicates the current use state of the heating oven. This may simply be a warning indicator which is active when a temperature of the aerosol generation device 1 is above a threshold, or may be a more detailed indicator of progress through an aerosol generating session.

In another example, a status indicator indicates whether the communication module 17 is enabled or disabled. This may, for example, indicate to the user that they should keep the aerosol generation device 1 within communication range of the remote device 2.

FIGS. 4C and 4D are partial cross-sections showing additional details of the aerosol generation device 100 inside the housing 102.

Firstly, the sliding closure 106 is linked to a rail 116 which constrains the sliding closure 106 to move along the rail 116. In FIG. 4C, a peg linked to the sliding closure 106 is near to a first end of the rail 116, and the sliding closure 106 is in the closed position. On the other hand, in FIG. 4D, the peg linked to the sliding closure 106 is near to a second end of the rail 116 opposing the first end, and the sliding closure 106 is in the open position.

Additionally, as shown in FIGS. 4C and 4D, the aerosol generation device 100 comprises an internal power source 118 (such as a battery). The internal power source 118 is configured to supply power to the control circuitry 12 and to the heating oven 114 (heating oven 11). The internal power source 118 may define a limitation on the power which can be supplied to the heating oven 114 and/or the communication module 17, and power usage limitations (such as disabling the communication module 17) may be implemented to reduce stress on the internal power source 118. In other embodiments, the aerosol generation device 100 may be configured to connect to an external power source, either for recharging the internal power source 118 or for directly powering the heating oven 114 and/or the communication module 17. Where an external power source is present, the internal power source 118 may be omitted.

Also, as shown in FIGS. 4C and 4D, in this example the control circuitry 12 takes the form of one or more PCB sections 120, on which the communication module 17 is located.

Furthermore, in order to control heat dissipation within the housing 102, a heat sink 122 may be attached to the heating oven 114. Although it is most preferable that heat does not leak out of the heating oven 114, the heat sink 122 serves the function of directing any heat that does leak from the heating oven 114 to move out of the housing 102 rather than heating up the control circuitry 120 or the internal power source 118.

1. An aerosol generation device comprising:
a heating oven configured to receive and heat an aerosol generating substrate to generate an aerosol; and
control circuitry configured to control the heating oven,
wherein the control circuitry comprises a communication module configured to communicate with a remote device, and the control circuitry is configured to enable or disable the communication module depending upon a current use state of the heating oven.
wherein the heating oven comprises an opening and a moveable closure for the opening, and the current use state of the heating oven comprises a position of the moveable closure.

2. The aerosol generation device according to claim 1, wherein the control circuitry is configured to enable the communication module when the moveable closure is in an open position, and/or the control circuitry is configured to disable the communication module when the moveable closure is in a closed position.

3. The aerosol generation device according to claim 1, wherein the current use state of the heating oven comprises a sequence of changes in the position of the moveable closure.

4. The aerosol generation device according to claim 1, wherein the moveable closure is a sliding closure configured to move along a rail.

5. The aerosol generation device according to claim 1, wherein the heating oven is configured to receive through the opening a consumable that is longer than the heating oven such that the moveable closure is in an open position when an aerosol generating substrate of the consumable is received in the heating oven.

6. The aerosol generation device according to claim 1, wherein the moveable closure is biased to a closed position.

7. The aerosol generation device according to claim 1, wherein the control circuitry is configured to control the heating oven to be in one or more aerosol generating states, and the current use state of the heating oven comprises a current aerosol generating state of the heating oven.

8. The aerosol generation device according to claim 1, further comprising a temperature sensor, and the current use state of the heating oven comprises an indication of a temperature measured by the temperature sensor.

9. The aerosol generation device according to claim 1, wherein the communication module is configured to transmit a current state to the remote device, wherein the current state is a current phase of an aerosol generation session.

10. The aerosol generation device according to claim 1, wherein the control circuitry is configured to enable the communication module when the current use state of the heating oven is an inactive state.

11. The aerosol generation device according to claim 1, wherein the communication module is configured to transmit usage data to the remote device.

12. The aerosol generation device according to claim 1, wherein the communication module is configured to receive an instruction from the remote device, and the control circuitry is configured to control the heating oven based on the instruction.

13. The aerosol generation device according to claim 1, wherein the control circuitry is configured to delay disabling the communication module until a communication session is complete.

14. The aerosol generation device according to claim 1, further comprising a communication indicator operable to indicate whether the communication module is enabled or disabled.

15. A system comprising the aerosol generation device according to claim 1 and a remote device, wherein the remote device is configured to run a software application for communicating with the aerosol generation device.

16. The system according to claim 15, wherein the communication module is a wireless communication module, and the remote device is a user terminal.

17. A method of controlling an aerosol generation device comprising:
a heating oven configured to receive and heat an aerosol generating substrate to generate an aerosol; and
a communication module configured to communicate with a remote device,
the method comprising enabling or disabling the communication module depending upon a current use state of the heating oven,
wherein the heating oven comprises an opening and a moveable closure for the opening, and the current use state of the heating oven comprises a position of the moveable closure.

18. A non-transitory computer-readable storage medium storing computer program instructions which, when executed by control circuitry of an aerosol generation device, cause the control circuitry to perform the method according to claim 17.

19. The aerosol generation device according to claim 1, further comprising a consumable including an aerosol generating substrate, the consumable being longer than the heating oven, wherein the heating oven is configured to receive the consumable through the opening such that the moveable closure is in an open position when the aerosol generating substrate of the consumable is received in the heating oven.
